(19) United States
(12) Patent Application Publication
(10) Pub. No.: US 2007/0298634 A1
(43) Pub. Date: Dec. 27, 2007

(54) TV baby-sitter

(76) Inventor: Adriana M. Castellano, Trumbull, CT (US)

Correspondence Address: CASTELLANO, ADRIANA M., 228 Strobel Rd., Trumbull, CT, 06611, US

(21) Appl. No.: 11/257,363

(22) Filed: Feb. 13, 2006

(51) Int. Cl. H01R 13/436

(52) U.S. Cl. 439/133

(57) ABSTRACT

The T.V. Baby-Sitter locks on to the plug of TVs, computers or electrical appliances making the plug unable to be plugged in to the outlet, therefore controlling their use. Inside the T.V. Baby-Sitter the lock and key are made of metal (316 or higher stainless steel), surrounded by the rest of it which is a strong, plastic and a good insulation for electricity. It comes with two metal (SS) keys and parents will love the T.V. Baby-Sitter! It is a safe and useful invention.

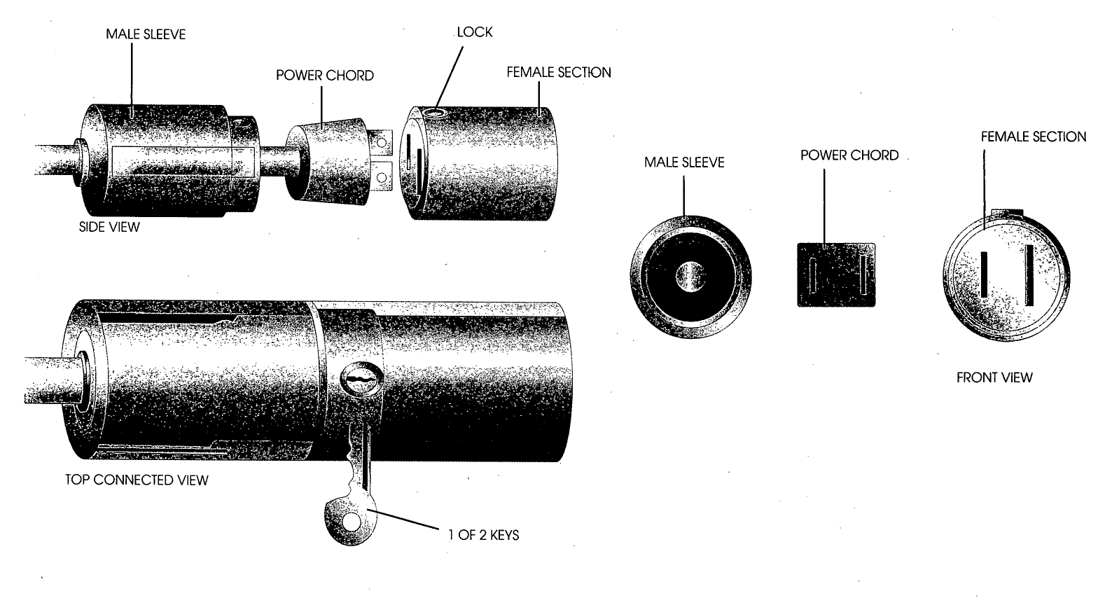

### SPECIFICATION, DETAILED DESCRIPTION

The T.V. Baby-Sitter is designed to control the use of TV's, computers or any electrical appliance by covering the plug; it is a lock-up system. With this invention parents can have more control over their children's activities and make sure that all homework is done before they are allowed to use the T.V, computer, etc.

After the plug is covered with the T.V. Baby-Sitter, then the key can be turned to lock it, and take the key out, now the plug is totally covered and will not be able to be plugged into the outlet.

1. I Adriana M. Castellano claim that my invention the T.V. Baby-Sitter is for controlling the use of TV's, computers or any electrical appliances, by covering the plug and locking it, making it unable to be plugged into the outlet. It comes with two keys.
